(19) United States
(12) Patent Application Publication
(10) Pub. No.: US 2002/0126977 A1
(43) Pub. Date: Sep. 12, 2002

(54) Tinted cable management system

(76) Inventor: Thomas Walter Kampf, Minnetonka, MN (US)

Correspondence Address: MERCHANT & GOULD PC, P.O. BOX 2903, MINNEAPOLIS, MN, 55402-0903, US

(21) Appl. No.: 09/802,290

(22) Filed: Mar. 8, 2001

(51) Int. Cl. G02B 6/00

(52) U.S. Cl. 385/134; 385/135

(57) ABSTRACT

A cable exit trough is mountable to a lateral trough section either during initial assembly of the cable routing system, or at a later date. The exit trough and the lateral trough are tinted so that they are transparent to visible light, but not clear or 100% transparent to visible light.

### FIELD OF THE INVENTION

The invention pertains to a system for the management and routing of optical fiber cables and other telecommunications cables, such as copper-based cables.

### BACKGROUND OF THE INVENTION

In the telecommunications industry, the use of optical fibers cables and other cables, such as copper-based cables, for signal transmissions is accelerating. With the increased utilization of these cable systems, cable management requires industry attention.

One area where cable management is necessary is the routing of optical fibers from one piece of optical fiber equipment to another. For example, in a telecommunications facility, optical fiber cables may be routed between fiber distribution equipment and optical line terminating equipment. In buildings and other structures which carry such equipment, the cable routing can take place in concealed ceiling areas or in any other manner to route cables from one location to another.

When routing telecommunications cables, it is desirable that any routing system will be readily modifiable and adaptable to changes in equipment needs. Accordingly, a routing system is not practical which would require a high capital outlay and which could not be readily adapted to changes in a customer's needs. Namely, if routing paths, once established, are forever fixed, the system cannot adapt. Also, and perhaps most important, any routing system must protect cables from damage. In the use of optical fibers, it is recognized that the fibers should not be bent beyond a minimum radius of curvature. For example, it is commonly recognized that optical fibers should not be bent in a radius of less than 1.5 inches.

Known routing systems typically include a multitude of system components, such as lateral troughs, downspouts, elbows, adapters, and horizontal Ts. Examples of such components are described and disclosed in each of the following references: U.S. Pat. No. 5,067,678, entitled “Optic Cable Management System”; U.S. Pat. No. 5,316,243, entitled “Optic Cable Management”; U.S. Pat. No. 5,752,781, entitled “Fiber Trough Coupling”; U.S. Pat. No. 5,923,753, entitled “Optic Cable Exit Trough With Bypass”; U.S. Pat. No. 5,937,131, entitled “Optical Cable Exit Trough”; U.S. Pat. No. 6,076,779, entitled “Cable Guiding Trough”; U.S. Pat. No. 6,192,181 B1, entitled “Optical Cable Exit Trough”; U.S. Pat. No. Des. 320,782, entitled “Guiding Trough Downspout For Optical Fibers”; U.S. Pat. No. Des. 320,976, entitled “Guiding Trough, Straight Reducing Adapter For Optical Fibers”; U.S. Pat. No. Des. 321,682, entitled “Guiding Through, 90 Degree Down Elbow For Optical Fibers”; U.S. Pat. No. Des. 321,862, entitled “Guiding Trough, Horizontal T For Optical Fibers”; U.S. Pat. No. Des. 321,863, entitled “Guiding Trough, 90 Degree Up Elbow For Optical Fibers”; U.S. Pat. No. Des. 322,596, entitled “Guiding Trough For Optical Fibers”; U.S. Pat. No. Des. 327,874, entitled “Guiding Trough 45° Horizontal Elbow For Optical Fibers”; U.S. Pat. No. Des. 334,380, entitled “Guiding Trough 90°, Degree Horizontal Elbow For Optical Fibers”; U.S. Pat. No. Des. 338,444, entitled “Guiding Trough, Square-To-Round Adaptor For Optical Fibers”; U.S. Pat. No. Des. 347,209, entitled “Fiber Trough Coupling”; U.S. Pat. No. Des. 348,651, entitled “Fiber Trough Coupling”; and the ADC Telecommunications brochure entitled “FiberGuide® Fiber Management System” dated May 2000.

In view of the increased installation of routing system components in unconcealed locations, it is desirable for the routing system to have a clean, professional, and high quality appearance. It is also desirable for the routing system to provide for the cables extending through the system to be visible from a point outside of the system, i.e., for the system components to be see-through. Having see-through components allows an individual to ascertain, for example, cable fill.

With opaque and colored system components, the visibility of the cables is not possible. Although clear (i.e., 100% transparent to visible light) system components render the cables visible, utilizing clear system components often prevents the routing system from having a clean, professional, and high quality appearance. For example, it is not uncommon for routing system components to be scuffed during manufacture or shipping. These scuffs are readily apparent in clear components, particularly as compared to opaque, colored system components. Also, it is not uncommon for dust or debris to collect in the routing system. With clear system components, the collected dust and debris can detract from the perceived quality of the system. Furthermore, it is not uncommon for cables extending through the system to have excess slack, which may appear unseemly.

### SUMMARY OF THE INVENTION

According to preferred embodiments of the present invention, a cable routing system is disclosed for routing optical fiber cables between optical transmission equipment. The system includes a lateral trough section configured for defining a cable pathway. An exit trough is mountable to the lateral trough section to provide a cable exit pathway from the lateral trough section. The exit trough may include a downspout portion defining a downwardly directed cable pathway, or a horizontal portion defining a horizontally directed cable pathway, or other directional pathway as desired. The cable trough section, the exit trough, and the downspout portion and other components are tinted so that they are transparent to visible light, but are not clear. Particularly, they are tinted with smoke tint.

Utilizing tinted system components provides for visibility of the cables extending through the routing system. The tinted system components also provide the system with a clean, professional, and high quality appearance, especially compared to a system utilizing clear system components. For example, scuff marks, dust, and debris are all less visible in a system utilizing translucent system components than in a system utilizing clear system components. Likewise, the cable lacing or placement is less visible through tinted system components than through clear components. Particularly, the tinted cable components effectively hide blemishes in the system while simultaneously providing visibility to the cables extending through the routing system.

### BRIEF DESCRIPTION OF THE DRAWINGS

FIG. 1 is a top, front, and left side perspective view of a lateral trough section and an exit trough mounted thereto according to one preferred embodiment of the present invention.

FIG. 2 is a bottom, back, and right side perspective view of the first embodiment.

FIG. 3 is a back view of the first embodiment.

FIG. 4 is a front view of the first embodiment, and showing the lateral trough section in cross-section through a middle of the lateral trough section.

FIG. 5 is a left side view of the first embodiment.

FIG. 6 is a top view of the first embodiment.

FIG. 7 is a bottom view of the first embodiment.

FIG. 8 is a left cross-sectional side view through the center of the lateral trough section and through the exit trough.

FIG. 9 is a top, front, and left side perspective view of a lateral trough section and an exit trough mounted thereto according to the second preferred embodiment of the present invention.

FIG. 10 is a bottom, back, and right side perspective view of the second embodiment.

FIG. 11 is a back view of the second embodiment.

FIG. 12 is a front view of the second embodiment, and showing the lateral trough section in cross-section through a middle of the lateral trough section.

FIG. 13 is a left side view of the second embodiment.

FIG. 14 is a top view of the second embodiment.

FIG. 15 is a bottom view of the second embodiment.

FIG. 16 is a left cross-sectional side view through the center of the lateral trough section and through the exit trough.

### DETAILED DESCRIPTION OF THE PREFERRED EMBODIMENTS

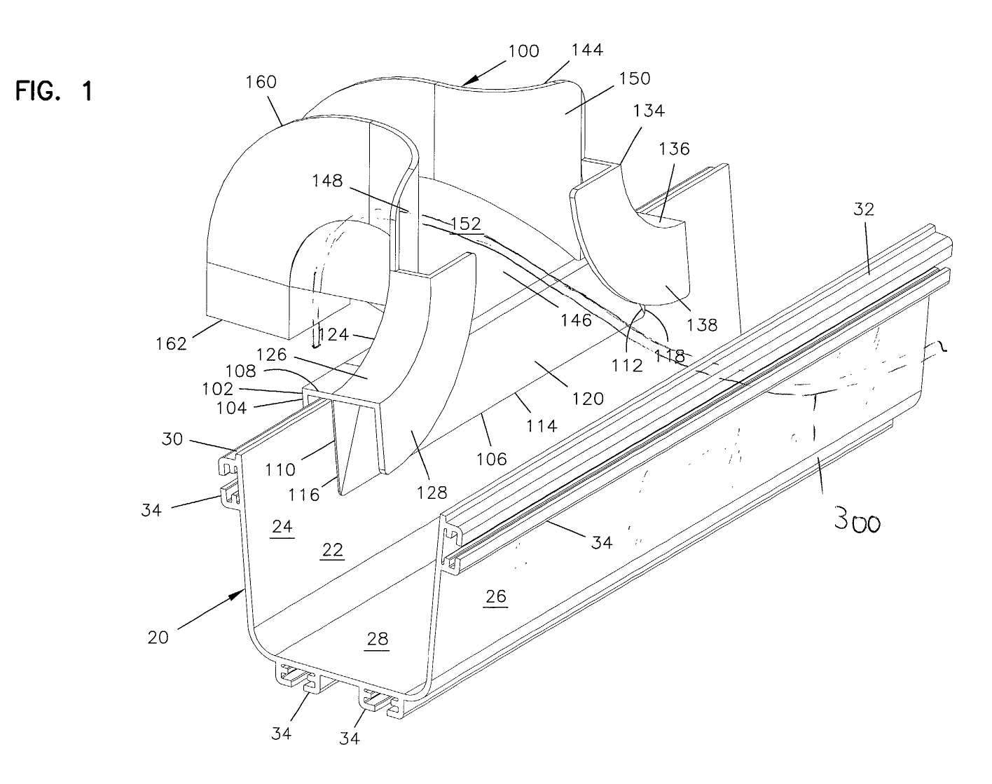

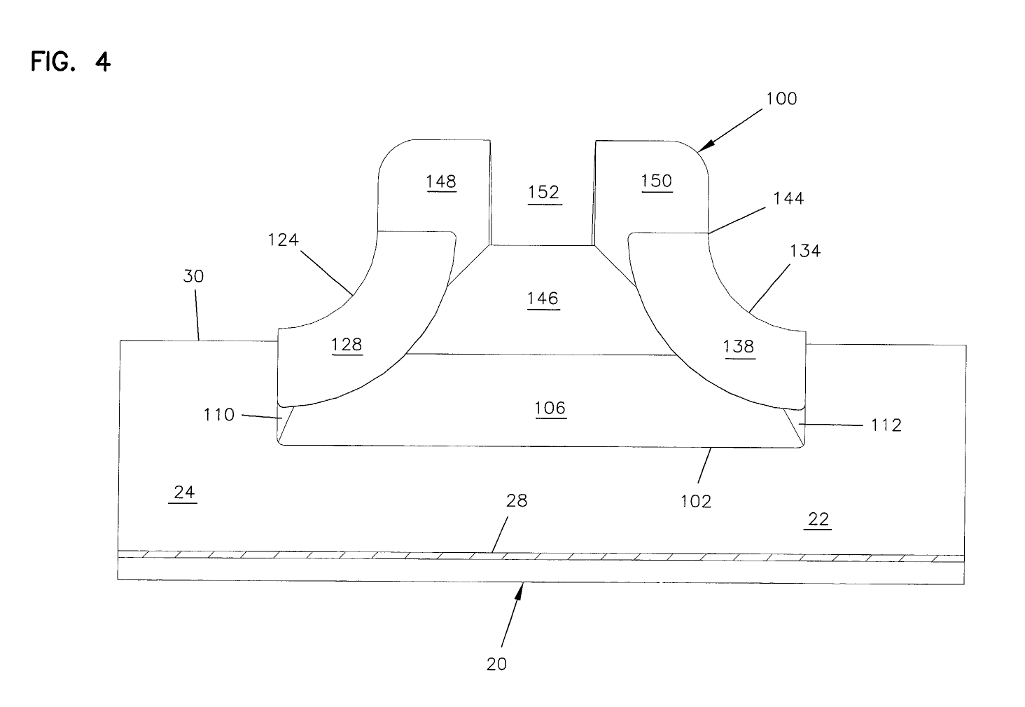

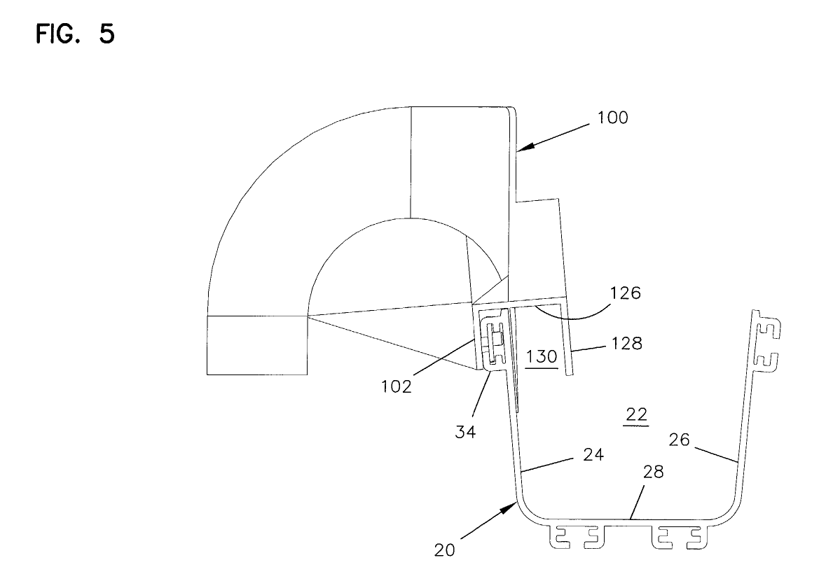

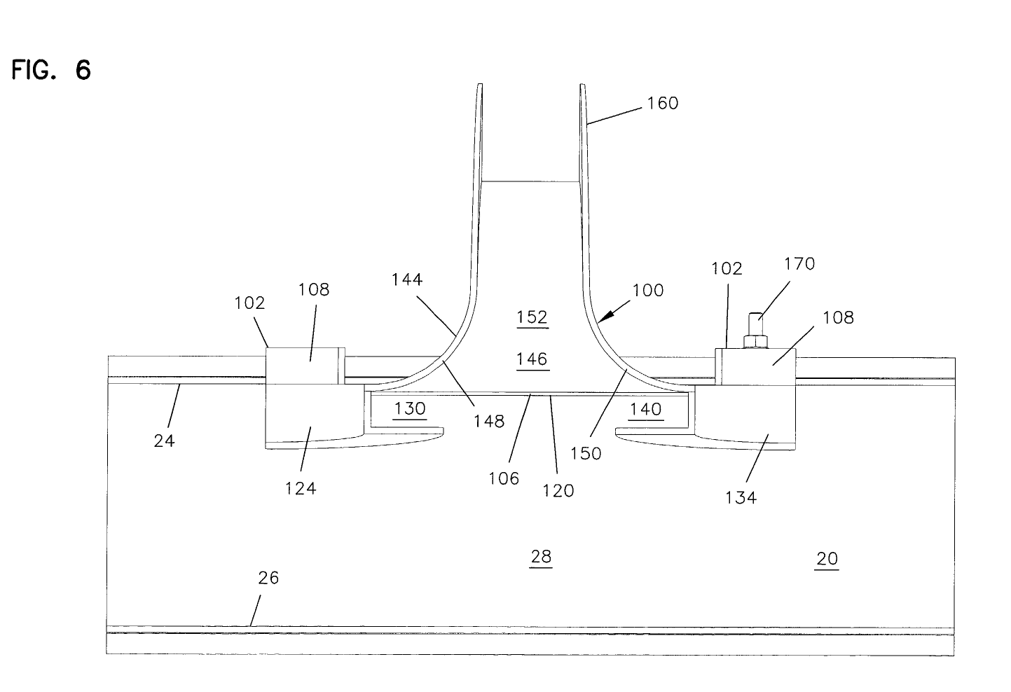

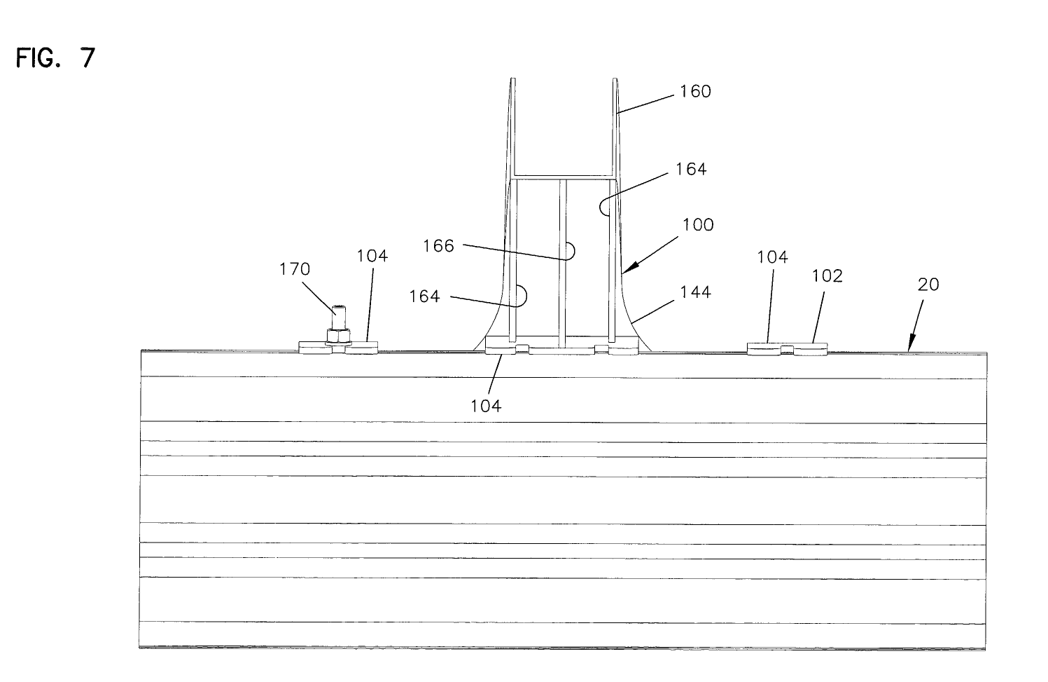

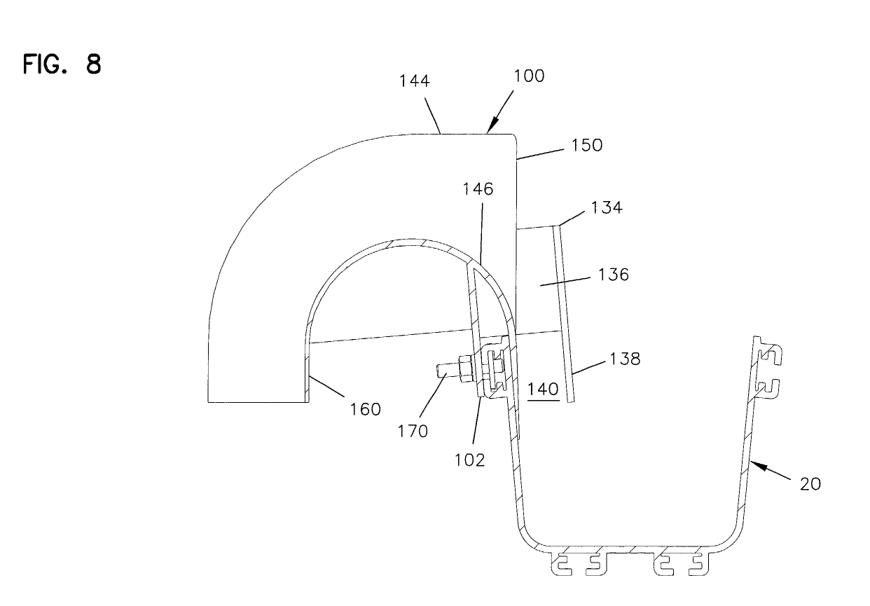

Referring now to FIGS. 1-8, a first embodiment of an exit trough 100 is shown mounted to a lateral trough section 20. Lateral trough section 20 defines a cable pathway 22 for routing optical fiber cables between locations. Lateral trough section 20 and exit trough 100 can be part of a cable routing system typically within a structure, such as a building having optical fiber signal transmitting equipment. Lateral trough section 20 typically is suspended from a ceiling structure by any suitable means (not shown). U.S. Pat. Nos. 5,067,678 and 5,316,243 disclose various cable routing systems, including lateral trough sections like lateral trough section 20 illustrated in FIGS. 1-8. Exit trough 100 is not only usable with lateral trough section 20 shown in FIGS. 1-8, but also with other cable routing systems disclosed in U.S. Pat. Nos. 5,067,678 and 5,316,243, the disclosures of which are hereby incorporated by reference, and other cable routing systems.

Generally, lateral trough section 20 includes first and second upstanding sides 24, 26, and a bottom 28 extending therebetween and defining cable pathway 22. Side 24 includes a top edge 30. Opposite side 26 also includes similar top edge 32. Lateral trough section 20 includes a plurality of attachment members 34 on an outside portion for use in attaching lateral trough sections 20 together end to end, or adding other system hardware.

As will be described below, exit trough 100 mounts to lateral trough section 20 adjacent to top edge 30 of side 24 through attachment member 34. Exit trough 100 creates a cable exit pathway from lateral trough section 20.

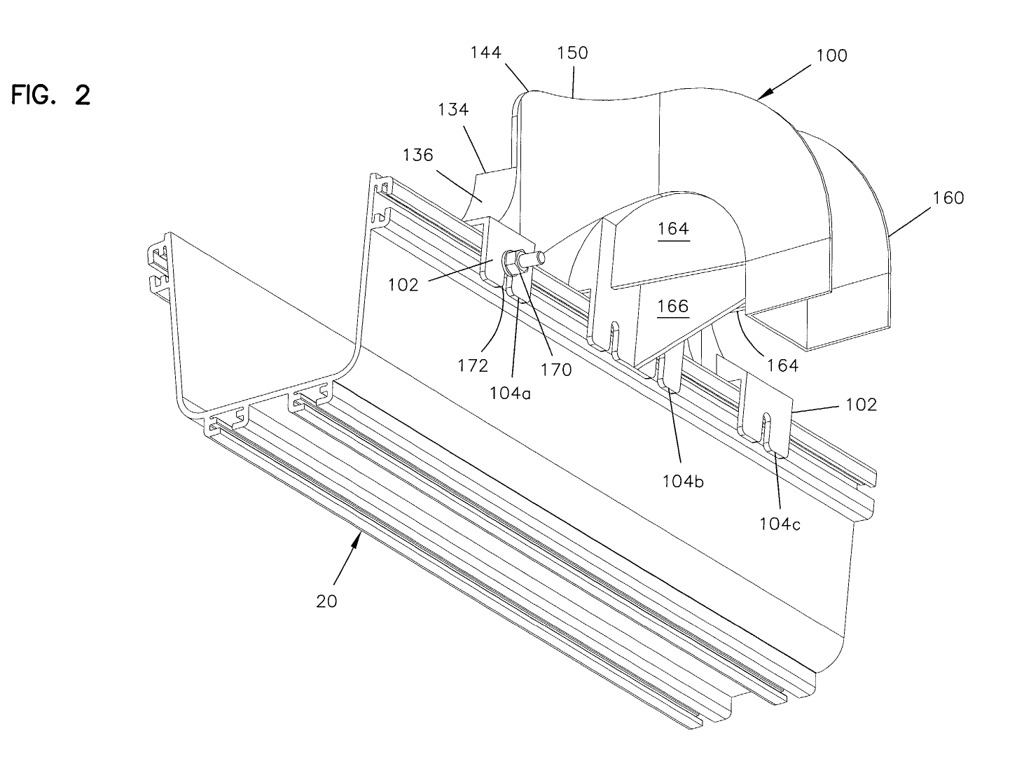

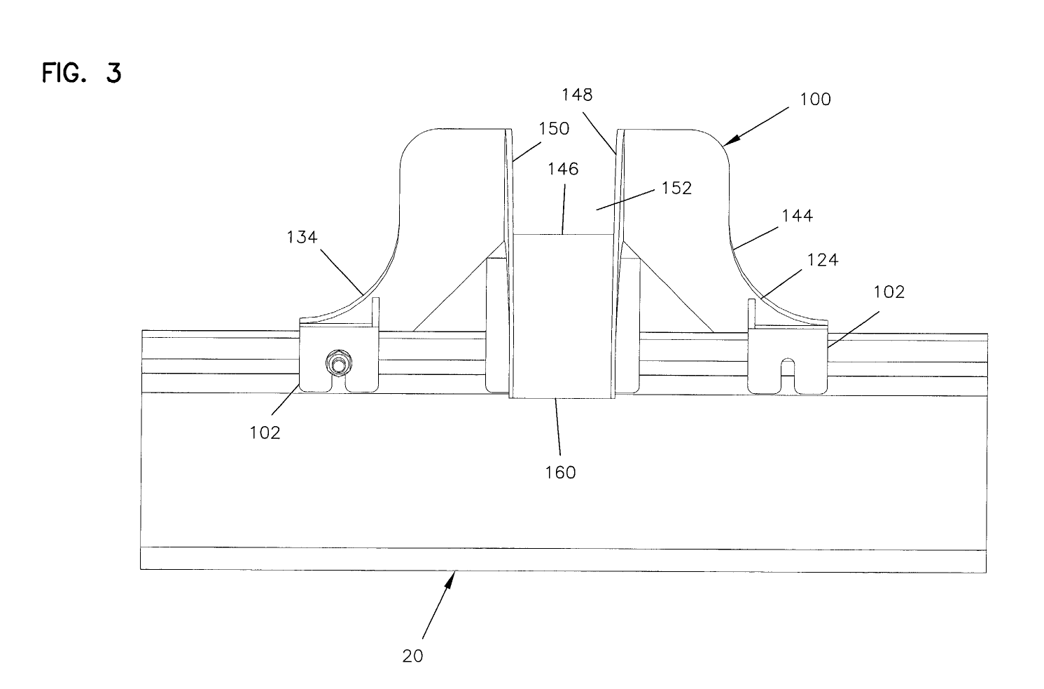

Exit trough 100 includes a bracket portion 102 including an outer projecting member 104, an inner projecting member 106, and a connecting member 108. Bracket portion 102 generally defines a U-shape for receipt of a portion of side 24 such that top edge 30 is positioned adjacent to connecting member 108. Exit trough 100 conveniently and securely mounts to lateral trough section 20 via one or more fasteners 170 positioned through outer projecting member 104 and engaged with attachment member 34 of lateral trough section 20, as shown in FIGS. 2, 3, and 5-8. As shown in FIGS. 2 and 3, outer projecting member 104 includes separate spaced apart portions 104a, 104b, 104c. Alternatively, the individual portions 104a-c could be constructed as a single piece. Portion 104a includes a slot 172 for receipt of fastener 170 during assembly. The other portions 104b and 104c include similar slots.

For protection of the optical fiber cables, inner projecting member 106 of bracket portion 102 includes tapered ends 110, 112, and a tapered middle 114. Bracket portion 102 generally extends from a first end 116 to a second end 118. A middle 120 is positioned between the first and second ends 116, 118. At first and second ends 116, 118, two cable lead-ins 124, 134 are provided. First lead-in 124 includes an upper surface portion 126 having an upwardly curved shape. A downwardly depending flange 128 extends toward bottom 28 of lateral trough section 20. Flange 128 is spaced apart from inner projecting member 106 of bracket portion 102 to define a cable pathway 130. Second lead-in 134 at an opposite end of bracket portion 102 faces in an opposite direction to first lead-in 124. Second lead-in 134 includes a similarly configured upwardly curved surface 136, and a downwardly depending flange 138 defining a cable pathway 140 for cables entering exit trough 100 from an opposite end of lateral trough section 20.

Exit trough 100 includes an exit trough portion 144 extending from bracket portion 102 at middle 120 away from lateral trough section 20. Exit trough portion 144 includes a bottom trough surface 146 and upstanding sides 148, 150 on opposite sides of bottom trough surface 146. Generally bottom trough surface 146 extends upwardly and away from top edge 30 of lateral trough section 20, and includes a convex shape. Upstanding sides 148, 150 extend from each respective lead-in 124, 134, and also define convex shapes. Exit trough portion 144 defines a cable pathway 152 linked to cable pathway 22 of lateral trough section 20 via cable pathways 130, 140 of lead-ins 124, 134.

In exit trough 100, exit trough portion 144 links lateral trough section 20 to a downspout 160. Downspout 160 generally provides a cable pathway for cable exiting in a downward direction relative to lateral trough section 20. Downspout 160 is supported by two side ribs 164 and a center rib 166 connected to bracket portion 104b.

With exit trough 100 mounted to lateral trough section 20, cable extending generally horizontally to the ground through lateral trough section 20 is allowed to route upwardly and away from lateral trough section 20, and then to route downwardly through downspout 160 for connection to optical transmission equipment, or other uses. Downspout 160 is connectable via any suitable means to other cable routing components, such as vertical troughs or conduit, as desired. The various curves provided with exit trough 100 help protect the optical fiber cables from being bent beyond a minimum radius of curvature.

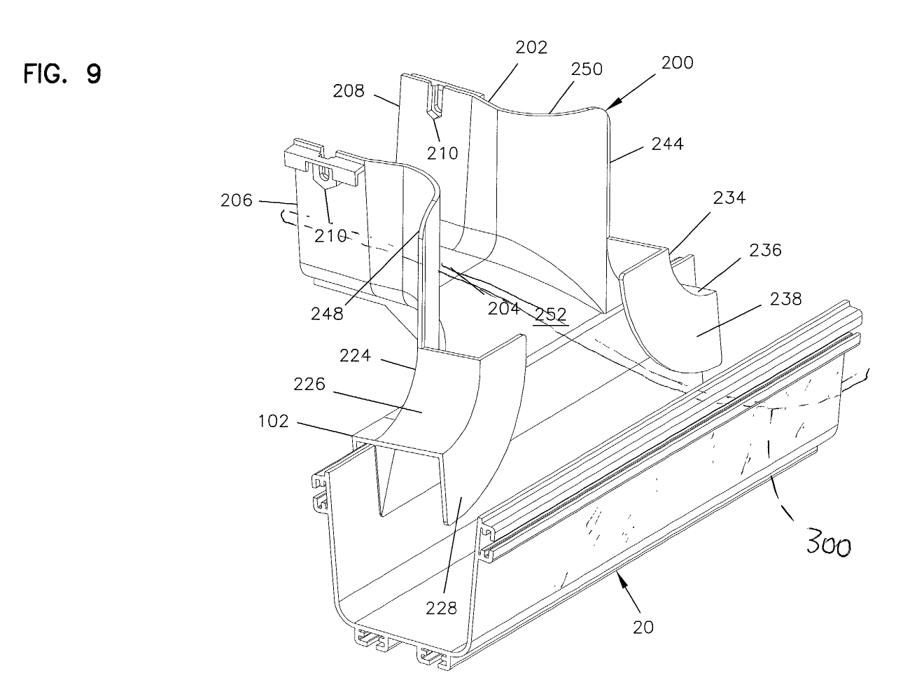

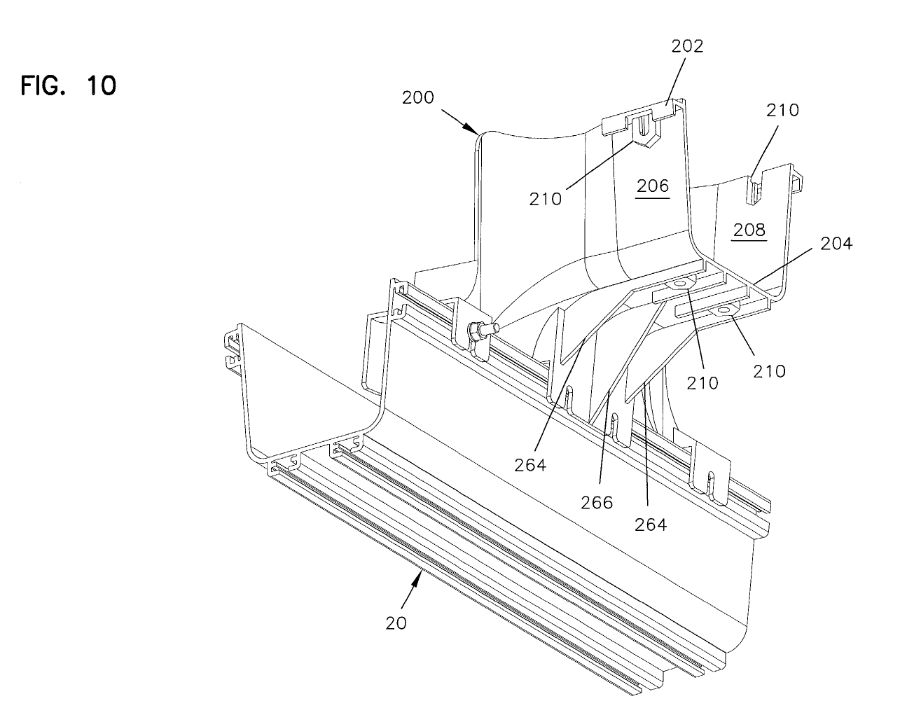

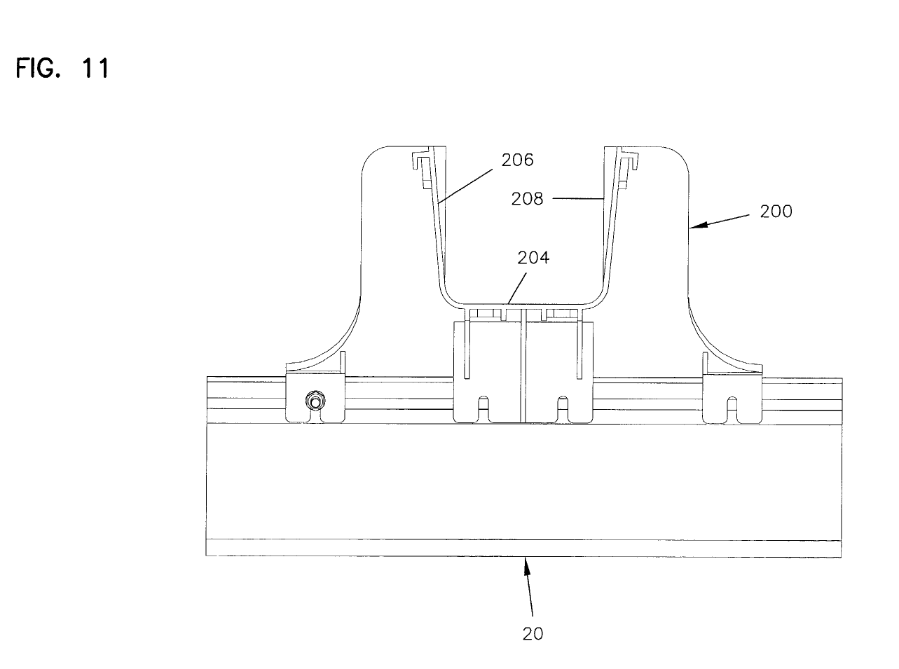

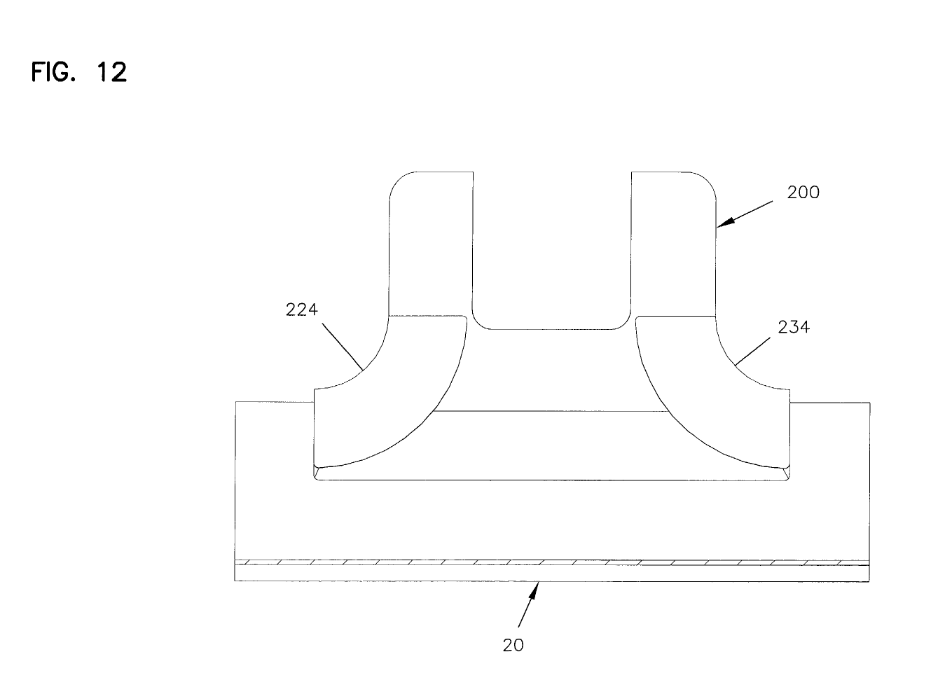

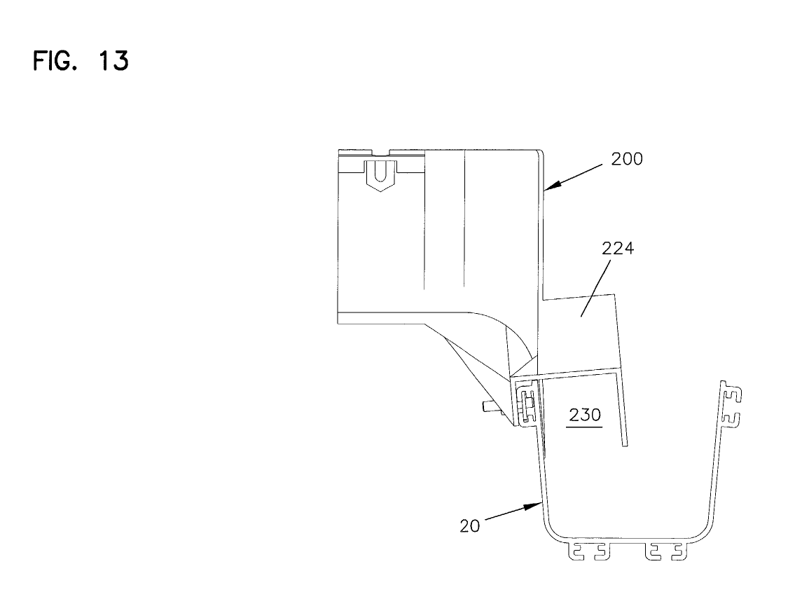

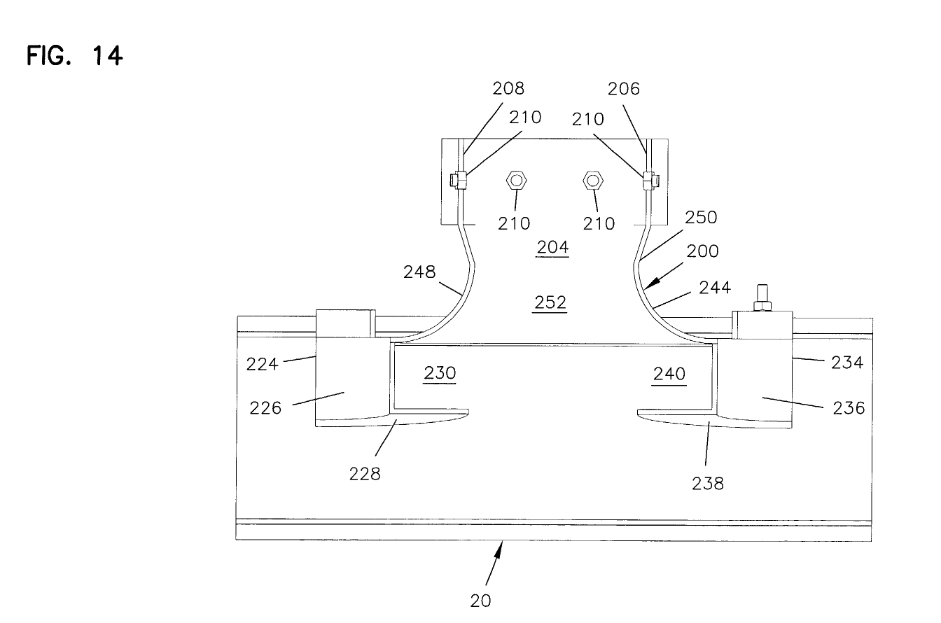

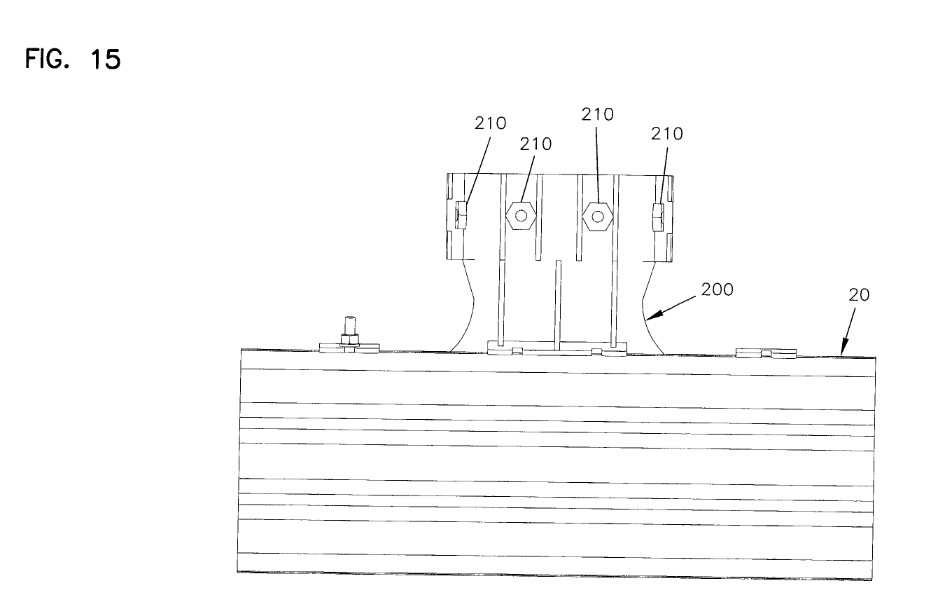

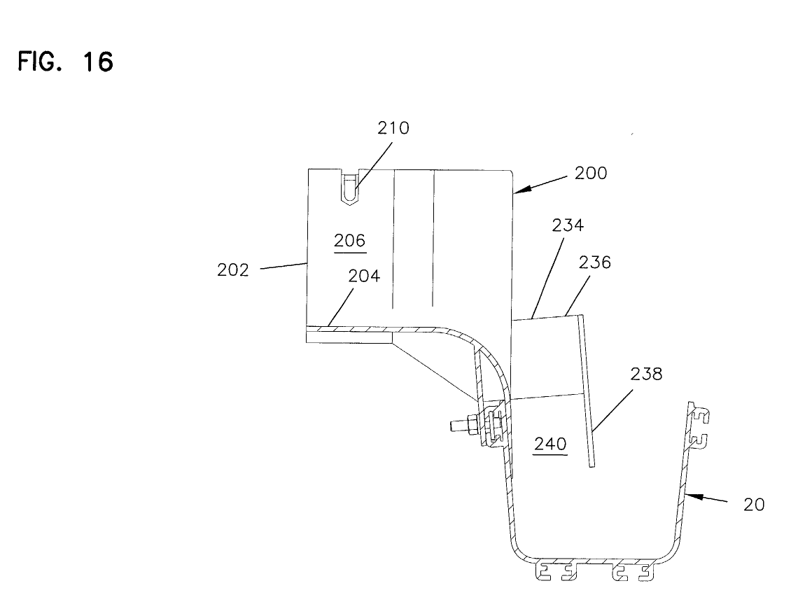

Referring now to FIGS. 9-16, a second embodiment of an exit trough 200 is shown. Like parts to parts in exit trough 100 are identified by the same reference numerals noted above for exit trough 100. Exit trough 200 differs in two main respects. First, instead of downspout 160, second exit trough 200 includes a horizontal portion 202 leading from exit trough portion 244. Horizontal portion 202 includes a generally horizontal bottom 204 and two upstanding sides 206, 208 leading from exit trough portion 244. Two side ribs 264, and a center rib 266 extending from bracket portion 102 support horizontal portion 202. Horizontal portion 202 is useful for linking lateral trough section 20 to other cable routing components interconnectable to horizontal portion 202 through any suitable means. Fastener recesses 210 are shown as one example of suitable structures for mounting to other components.

A second main difference between the second exit trough 200 and the first exit trough 100, is that lead-ins 224, 234 and exit trough portion 244 are sized to define larger cable pathways 230, 240, and 252. Specifically, upper surface portions 226, 236 and flanges 228, 238 are sized for defining the larger pathways 230, 240 relative to pathways 130, 140 of first exit trough 100. Also upstanding sides 248, 250 are taller and spaced further apart to define larger pathway 252 relative to pathway 152 of first exit trough 100. This illustrates that relative sizes of the features of exit troughs 100, 200 can be varied depending on the cable routing needs in the system.

Each of the disclosed exit troughs 100, 200 allows for exit pathways from the lateral trough section 20 without modification to the lateral trough section 20. This is useful during initial system setup, and also during modifications of the system at later dates. Exit troughs 100, 200 can be added at any time quickly and easily. Cable damage is avoided since any cables in lateral trough section 20 are not disturbed and do not have to be moved when exit troughs 100, 200 are added. Also, simple fasteners are all that is needed to mount the bracket portion 102 of the exit troughs 100, 200 to the lateral trough section 20. In addition to the downspout 160, and the horizontal portion 202, other directional components are possible from exit trough portions 144, 244 of each exit trough 100, 200.

Each of the optical fiber routing system components described above, such as exit trough 100, exit trough 200, lateral trough section 20, and downspout 160, is transparent to visible light, but not clear. Each such system component is formed of polycarbonate that is tinted with a smoke color so that the visibility of the cables is diminished but not excessively obstructed. Referring to FIGS. 1 and 9, a cable 300 is visible through the system components. For example, lateral trough 20 and exit troughs 100 and 200 are formed of LEXAN® RL 7609 available from General Electric Plastics. The troughs could also be formed of a different polycarbonate such as, for example, LEXAN® ML 7609, also available from General Electric Plastics. Downspout 160 is formed of LEXAN® 7612 available from General Electric Plastics. Downspout 160 could be formed of a different polycarbonate such as, for example, LEXAN® 943 A, also available from General Electric Plastics. Each of the components 20, 100, 200, and 160 are tinted a smoke color, such as the smoke color associated with the following General Electric Plastics x, y, and z color coordinates: x =36.88; y =37.3; and z=43.81. The components 20, 100, 200, and 160 may be tinted so that when a nominal 0.100 inch thick specimen of polycarbonate is tested in accordance with the American Society for Testing and Materials (ASTM) D 1003 method, the polycarbonate forming the component is approximately 60.17% transparent (i.e., light transmission through the polycarbonate is approximately 60.17%) and 0.7% haze. Each system component 20, 100, 200, and 160 is typically formed of polycarbonate having a thickness that ranges from about 0.060 inches to about 0.135 inches.

While exemplary polycarbonate light transmission percentages and haze percentages deduced in accordance with the ASTM D 1003 method are described above, it is to be understood that the polycarbonate forming troughs 20, 100, and 200, and downspout 160 may have a light transmission percentage of either greater or less than 60.17% and a haze percentage either greater or less than 0.7%. Likewise, it is to be understood that the thickness of the polycarbonate forming troughs 20, 100, and 200, and downspout 160 may be outside of the range of 0.060 inches to 0.135 inches. Furthermore, it is to be understood that the system components 20, 100, 200, and 160 may be tinted some color other than smoke.

While exemplary cable exit troughs and a lateral trough are discussed and described in detail above and in the drawings, it is to be understood that other components of the cable routing system are likewise transparent to visible light, but not clear. Exemplary system components having this feature include, without limitation, 90° down elbows, 90° up elbows, 45° up elbows, 45° down elbows, 45° horizontal elbows, 90° horizontal elbows, straight adaptors, horizontal Ts, crosses, and junctions. Such system components are well known and are described and disclosed, for example, in the following U.S. Pats., each of which is assigned to the present assignee, and the disclosures of which are herein incorporated by reference: U.S. Pat. No. 5,067,678, entitled “Optic Cable Management System”; U.S. Pat. No. 5,316,243, entitled “Optic Cable Management”; U.S. Pat. No. 5,752,781, entitled “Fiber Trough Coupling”; U.S. Pat. No. 5,923,753, entitled “Optic Cable Exit Trough With Bypass”; U.S. Pat. No. 5,937,131, entitled “Optical Cable Exit Trough”; U.S. Pat. No. 6,076,779, entitled “Cable Guiding Trough”; U.S. Pat. No. 6,192,181 B1, entitled “Optical Cable Exit Trough”; U.S. Pat. No. Des. 320,782, entitled “Guiding Trough Downspout For Optical Fibers”; U.S. Pat. No. Des. 320,976, entitled “Guiding Trough, Straight Reducing Adapter For Optical Fibers”; U.S. Pat. No. Des. 321,682, entitled “Guiding Through, 90 Degree Down Elbow For Optical Fibers”; U.S. Pat. No. Des. 321,862, entitled “Guiding Trough, Horizontal T For Optical Fibers”; U.S. Pat. No. Des. 321,863, entitled “Guiding Trough, 90 Degree Up Elbow For Optical Fibers”; U.S. Pat. No. Des. 322,596, entitled “Guiding Trough For Optical Fibers”; U.S. Pat. No. Des. 327,874, entitled “Guiding Trough 45° Horizontal Elbow For Optical Fibers”; U.S. Pat. No. Des. 334,380, entitled “Guiding Trough, 90° Degree Horizontal Elbow For Optical Fibers”; U.S. Pat. No. Des. 338,444, entitled “Guiding Trough, Square-To -Round Adaptor For Optical Fibers”; U.S. Pat. No. Des. 347,209, entitled “Fiber Trough Coupling”; and U.S. Pat. No. Des. 348,651, entitled “Fiber Trough Coupling.” Such components are also described and disclosed in the ADC Telecommunications brochure entitled “FiberGuide® Fiber Management System” dated May 2000, the disclosure of which is incorporated herein by reference. Each of these additional components, like lateral trough 20, generally includes a cable carrying surface and first and second upstanding sides extending from the cable carrying surface to define a cable pathway. Likewise, these additional components are formed of polycarbonate such as, for example, LEXAN® 7612 or LEXAN® ML7609.

Having described the present invention in a preferred embodiment, modifications and equivalents may occur to one skilled in the art. It is intended that such modifications and equivalents shall be included within the scope of the claims which are appended hereto.

What is claimed is:

1. A cable router for routing telecommunications cables, said cable router comprising:
a body having a cable carrying surface and first and second upstanding sides extending from said cable carrying surface to define a cable pathway;
wherein at least one portion of said body is transparent to visible light but is not clear.

2. A cable router in accordance with claim 1, wherein said body is formed of polycarbonate.

3. A cable router in accordance with claim 1, wherein said body comprises a lateral trough.

4. A cable router in accordance with claim 1, wherein said body comprises an optical cable exit trough.

5. A cable router in accordance with claim 1, wherein said body comprises a downspout.

6. A cable routing system, said cable routing system comprising:
at least one cable router, said cable router having a cable carrying surface and first and second upstanding sides extending from said cable carrying surface to define a cable pathway; and
a cable, said cable extending at least partially through said cable pathway.

7. A cable routing system in accordance with claim 6, wherein said cable routing system comprises at least two cable routers, each of said cable routers having a cable carrying surface and first and second upstanding sides extending from said cable carrying surface to define a cable pathway.

8. A cable routing system in accordance with claim 6 wherein said at least one cable router is a lateral trough.

9. A cable routing system in accordance with claim 6 wherein said at least one cable router is a downspout.

10. A cable routing system in accordance with claim 6 wherein said at least one cable is an elbow.

11. A cable routing system in accordance with claim 6 wherein said cable comprises an optical fiber.

12. A method of assembling a telecommunications cable routing system comprising the steps of:
providing a body having a cable carrying surface and first and second upstanding sides extending from said cable carrying surface to define a cable pathway, wherein at least a portion of said body is transparent to visible light but is not clear; and
routing a cable through the cable pathway.

13. The method of claim 12, wherein the body comprises a lateral trough section coupled to an exit trough, and wherein the step of routing a cable through the cable pathway comprises the step positioning the cable so that the cable passes through the exit trough and passes in a downward direction relative to the lateral trough section as the cable exits the exit trough.

14. The method of claim 12, wherein the body comprises a lateral trough section coupled to an exit trough, and wherein the cable passes through the exit trough and passes in a horizontal direction relative to the lateral trough section as the cable exits the exit trough.

15. The method of claim 12, wherein the step of routing a cable through the cable pathway comprises positioning an optical fiber in the cable pathway.
